(19) United States
(12) Patent Application Publication
(10) Pub. No.: US 2025/0385282 A1
(43) Pub. Date: Dec. 18, 2025

(54) CROSS-FLOW THREE-WAY AMMONIA-TO-AIR HEAT EXCHANGER FOR AIR CONDITIONING APPLICATIONS ON AN AIRCRAFT

(71) Applicant: Hamilton Sundstrand Corporation, Charlotte, NC (US)

(72) Inventors: Viktor Kilchyk, Lancaster, NY (US); Debabrata Pal, Hoffman Estates, IL (US)

(21) Appl. No.: 18/742,403

(22) Filed: Jun. 13, 2024

(51) Int. Cl. H01M 8/04014; B64D 41/00; H01M 8/04007; H01M 8/04082; H01M 8/0444; H01M 8/0662

(52) U.S. Cl. CPC H01M 8/04022; B64D 41/00; H01M 8/04067; H01M 8/04201; H01M 8/04485; H01M 8/0662; B64D 2041/005; H01M 2250/20

(57) ABSTRACT

An aircraft system for pre-heating ammonia that flows toward an ammonia fuel cell, the system having: an ammonia-to-air heat exchanger, having: a first section through which RAM air flows, a second section through which the ammonia flows and a third section between the first and second sections which includes a solvent, wherein heat energy is transferred from the RAM air to the ammonia via the solvent; and an ammonia sensor that provides an alert when ammonia is detected in the solvent.

### BACKGROUND

The embodiments herein relate to air conditioning systems for an aircraft and more specifically to a cross-flow three-way ammonia-to-air heat exchanger for air conditioning applications of an aircraft.

It is desirable to utilize green technology fuel, such as ammonia, which may be volatile and toxic, to power a jet engine for supersonic and near-supersonic aircraft and in aircraft refrigeration systems. In aircraft that utilizes typical types of fuel, air-to-fuel heat exchangers have been employed to condition, e.g., RAM air and the fuel. To avoid fuel-air contamination and resulting complications, the heat exchangers may separate the fuel and air via an intermediate separation chamber.

### BRIEF SUMMARY

An aircraft system for pre-heating ammonia that flows toward an ammonia fuel cell, the system including: an ammonia-to-air heat exchanger, having: a first section through which RAM air flows, a second section through which the ammonia flows and a third section between the first and second sections which includes a solvent, wherein heat energy is transferred from the RAM air to the ammonia via the solvent; and an ammonia sensor that provides an alert when ammonia is detected in the solvent.

In addition to one or more aspects of the system or as an alternate the ammonia sensor is in the third section of the heat exchanger.

In addition to one or more aspects of the system or as an alternate the solvent is sealed in the third section of the heat exchanger.

In addition to one or more aspects of the system or as an alternate the solvent flows through the third section of the heat exchanger.

In addition to one or more aspects of the system or as an alternate flow characteristics through the third section of the heat exchanger is adjustable to change a heat transfer rate between the RAM air and the ammonia.

In addition to one or more aspects of the system or as an alternate including an environmental control system (ECS) that is fluidly coupled to the third section of the heat exchanger, wherein the ECS receives the solvent from the heat exchanger.

In addition to one or more aspects of the system or as an alternate an ECS conduit fluidly couples the third section of the heat exchanger and the ECS, and the ammonia sensor is in the ECS conduit.

In addition to one or more aspects of the system or as an alternate the system includes a secondary aircraft system, fluidly coupled to the ECS, wherein the ECS receives the solvent from the ECS to thereby cool the secondary aircraft system.

In addition to one or more aspects of the system or as an alternate the secondary aircraft system includes aircraft electronics.

In addition to one or more aspects of the system or as an alternate the system includes an ammonia storage system, fluidly coupled to the second section of the heat exchanger, that supplies the ammonia to the heat exchanger.

In addition to one or more aspects of the system or as an alternate the system includes an ammonia cracker, fluidly coupled to the second section of the heat exchanger, that receives the ammonia from the heat exchanger.

In addition to one or more aspects of the system or as an alternate the system includes an ammonia cracker, fluidly coupled to the second section of the heat exchanger, that receives the ammonia from the heat exchanger.

In addition to one or more aspects of the system or as an alternate the system includes a plurality of the heat exchangers including a first heat exchanger in a first conduit that extends between the ammonia storage system and the jet engine and a second heat exchanger between the ammonia storage system and the ammonia cracker.

In addition to one or more aspects of the system or as an alternate the system includes heat fins within the third section of the heat exchanger.

An aircraft system, including: a vapor compression cycle (VCS), that includes ammonia as the working fluid, wherein the VCS includes an evaporator; a heat exchanger coupled to the evaporator, wherein RAM air flows through the heat exchanger and is cooled by the evaporator. a secondary system air duct, coupled to the heat exchanger, that receives the RAM air cooled by the evaporator.

In addition to one or more aspects of the aircraft system or as an alternate the system includes an environmental control system (ECS) that is fluidly coupled to the heat exchanger and receives the RAM air that is cooled by the VCS.

### BRIEF DESCRIPTION OF THE DRAWINGS

The following descriptions should not be considered limiting in any way. With reference to the accompanying drawings, like elements are numbered alike:

FIG. 1 is a schematic illustration of an aircraft having an ammonia fueled jet engine, where the aircraft may employ various aspects of the present disclosure;

FIG. 2 shows the aircraft system with the ammonia fueled jet engine and a heat exchanger that preheats the ammonia;

FIG. 3 shows additional aspects of the heat exchanger; and

FIG. 4 shows an aircraft with a vapor compression cycle (VCS) having ammonia as a working fluid, where the evaporator of the VCS is utilized to cool RAM air, and the RAM air is utilized by an environmental control system (ECS).

### DETAILED DESCRIPTION

A detailed description of one or more embodiments of the disclosed apparatus and method are presented herein by way of exemplification and not limitation with reference to the Figures.

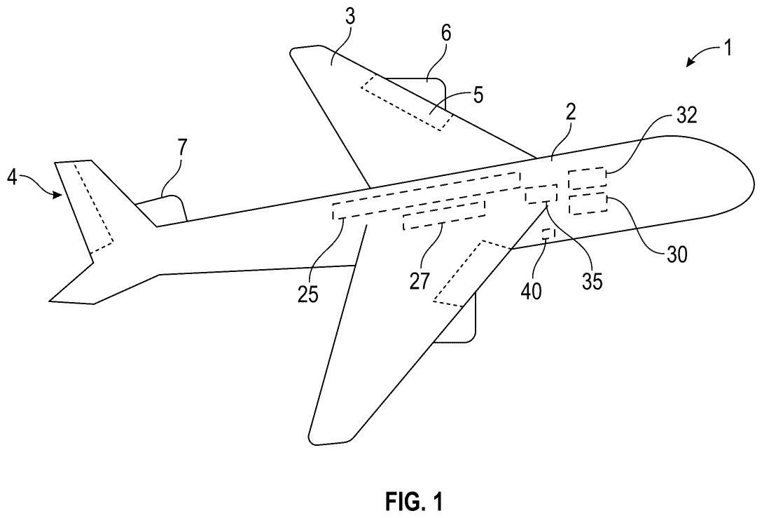

FIG. 1 shows an aircraft 1 having a fuselage 2 with a wing 3 and tail assembly 4, which may have control surfaces 5. The wing 3 may include an engine 6, such as an ammonia fueled jet engine (or an ammonia fuel cell), and an auxiliary power unit 7 may be disposed at the tail assembly 4. The aircraft 1 may have a cabin 25, a cargo bay 27, an environmental control system (ECS) 30 for conditioning the cabin 25, cargo bay 27 or one or more subsystems 35 of the aircraft 1. In one embodiment, the subsystems 35 include aircraft electronics. A RAM air inlet 40 may scoop air for the ECS 30. The aircraft 1 may include a vapor compression system (VCS) 32 that may utilize ammonia as its working fluid.

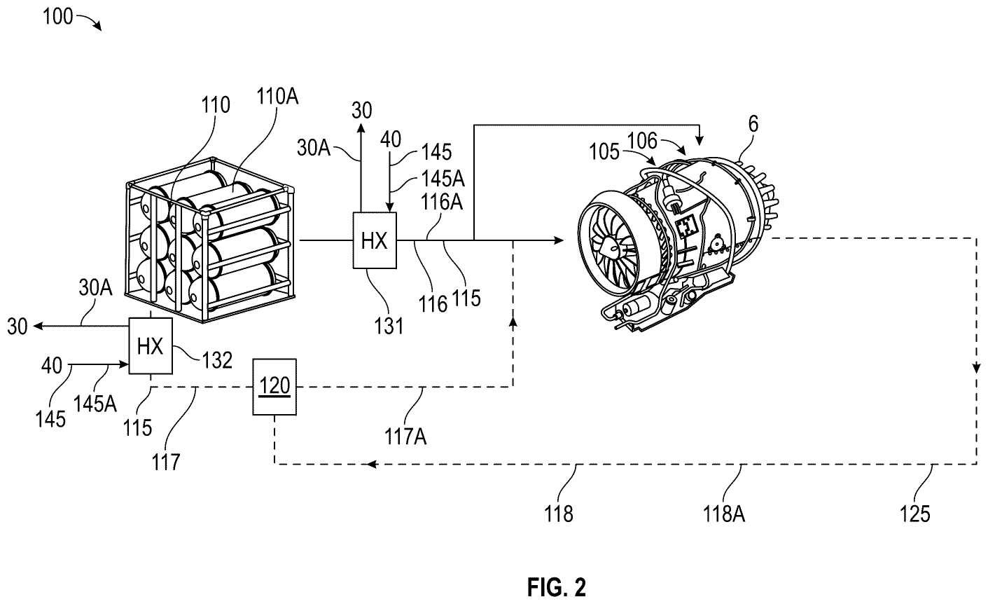

Turning to FIG. 2, an aircraft system 100 is shown for pre-heating ammonia that flows toward the combustor 105 of the jet engine 6. Preheating the ammonia provides for more efficient combustion in the combustor 105, resulting in a greater amount of heat energy being transferred to the turbine 106 of the engine 6. This, in turn, leads to increased power generation and improved overall efficiency of the jet engine 6.

The system 100 includes an ammonia storage system 110 that stores ammonia for utilization as combustible fuel by the jet engine 6. The ammonia storage system 110 may include refillable tanks 110A that store liquid ammonia. An ammonia flow 115 may be directed along a first flow path 116 via a first conduit 116A between the ammonia storage 110 and the engine 6, and specifically the combustor 105 of the engine 6. Alternatively, the ammonia flow 115 may be directed along a second flow path 117 via a second conduit 117A between the ammonia storage 110 and the engine 6, where the second flow path 117 includes an ammonia cracker 120 (a.k.a., a catalytic cracking furnace). The ammonia cracker 120 separates the ammonia into hydrogen (H2), nitrogen (N2) and residual ammonia (NH3), where the nitrogen is dumped overboard to reduce nitrogen oxides (NOx) in the engine 6. A portion 125 of engine exhaust may be directed along third flow path 118 via a third conduit 118A between the engine 6 and the ammonia cracker 120 to provide heat energy to the ammonia cracker 120 for its operation.

In one embodiment, a first three-way heat exchanger (or first heat exchanger) 131 of the ECS 30 is in the first flow path 116. In addition, or as an alternative, a second three-way heat exchanger (or second heat exchanger) 132 of the ECS is in the second flow path 117. The first and second heat exchangers 131, 132 of the ECS may be the same as each other and for simplicity each heat exchanger of the ECS 30 will be referred to as a heat exchanger 130. As discussed in greater detail below, the heat exchanger 130 receives a hot RAM air flow 145, e.g., from the RAM air inlet 40 via a RAM air conduit 145A, which is cooled by a flow of liquid ammonia from the tanks 110A. At relatively high speeds of the aircraft 1, the RAM air flow 145 is relatively hot due to its high stagnation temperature. The RAM air flow 145 is then cooled in the heat exchanger 130 by the ammonia flow 115, and directed to the ECS 30 via an ECS conduit 30A. At the same time the ammonia flow is heated, which increases temperature of the flow into the ammonia cracker 120 and thereby increases the efficiency of the ammonia cracker 120. From the ECS 30, the RAM air flow 145 is redirected to one or more of the cabin 25, cargo bay 27 or the subsystems 35 (FIG. 1).

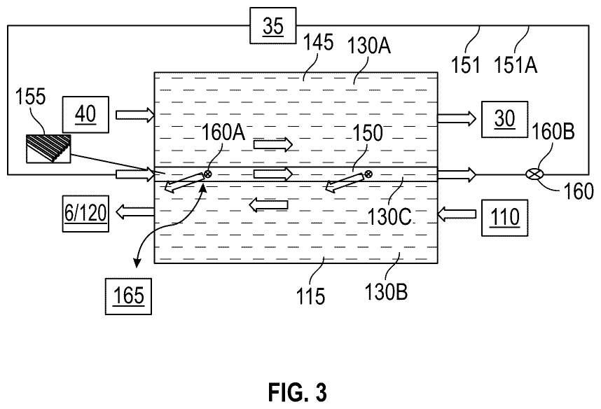

FIG. 3 shows additional aspects of the heat exchanger 130. The heat exchanger 130 has a first section (or compartment) 130A through which the RAM air flow 145 travels. The RAM air flow 145 travels between the RAM air inlet 40 and the ECS 30. A second section (or compartment) 130B is included, through which the ammonia flow 115 travels and may move in an opposite direction as the RAM air flow 145. The ammonia flow 115 travels between the ammonia storage 110 and either the engine 6 or the ammonia cracker 120, depending on whether the heat exchanger 130 is utilized as the first or second heat exchanger 131, 132. A third section (or compartment) 130C is between the first and second sections 130A, 130B. A solvent flow 150 travels through the third section 130C. The solvent flow 150 is shown as traveling in the same direction as the RAM air flow 145. These flow directions are not intended on limiting the scope the embodiments. The solvent flow 150 is one in which the ammonia flow 115 can dissolve should there be a breach between the second and third sections 130B, 130C, to prevent the ammonia flow 115 from reaching the RAM air flow 145 that travels to the ECS 30. The solvent flow 150 may be non-toxic, non-flammable and have a relatively high heat transfer coefficient and may be, e.g., water, an ethanol water solution, or salted water. The solvent flow 150 may be directed along a fourth flow path 151, via a fourth conduit 151A, to the aircraft subsystems 35, such as aircraft electronics, for cooling. In one embodiment, the third section 130C of the heat exchanger 130 has heat fins 155 that enhance heat transfer from the RAM air flow 145 to the ammonia flow 115.

In the above embodiment, adjusting the velocity or density (including vacuum) of the solvent flow 150, i.e., the flow characteristic of the solvent flow 150, can adjust the heat transfer between the RAM air flow 145 and the ammonia flow 115.

In one embodiment fluid in the third section 130C may be stationary, i.e., sealed in the third section. The solvent in such embodiment is utilized as a buffer layer for ammonia retention and detection, and to control heat flux between the RAM air flow 145 and ammonia flow 115, preventing icing on the air side.

An ammonia sensor 160 may be provided to detect ammonia dissolved in the flow 150 of the solvent. If the sensor 160 detects the ammonia, an alert may be issued, and the aircraft 1 may be serviced at the next available opportunity. There may be ammonia in the solvent flow 150 if, as indicated, there is a breach between the second and third sections 130B, 130C of the heat exchanger 130. In one embodiment the sensor 160 is a first sensor 160A located in the third section 130C of the heat exchanger 130. In one embodiment, the sensor 160 is a second sensor 160B located in the fourth flow path 151, between the heat exchanger 130 and the subsystem 35. In one embodiment, the sensor 160 is operationally coupled an aircraft controller 165 to enable communicating the appropriate alert to maintenance personnel. Benefits of the above embodiment includes the ability to detect a failure in the heat exchanger 130 and prevent ignition of ammonia.

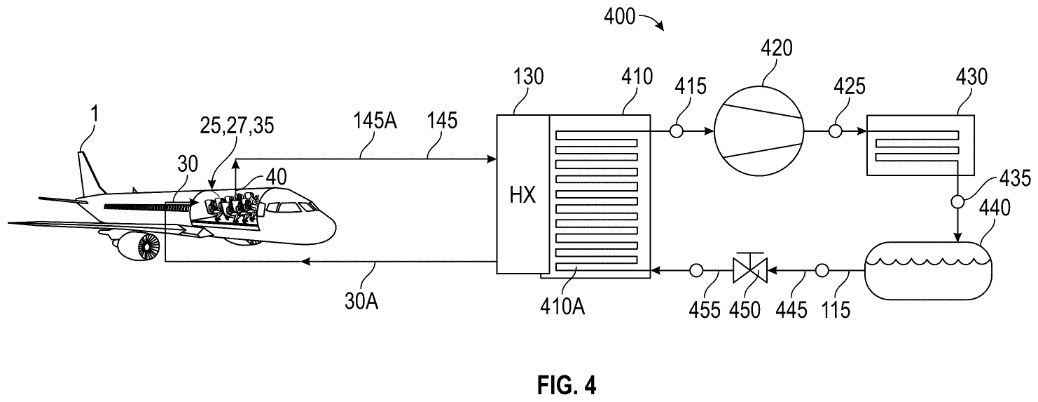

Turning to FIG. 4, an aircraft system 400 of an aircraft 1 is shown for treating a RAM air flow 145, e.g., obtained from the RAM air inlet 40, that is directed to an ECS 30, and thereafter to, e.g., a cabin 25, a cargo bay 27 or an aircraft subsystem 35. The system 400 includes the vapor compression cycle (VCS) 32, that includes ammonia as the working fluid. The VCS 32 includes an evaporator 410, a compressor 420, a condenser 430, a high pressure receiver 440, and an expansion valve 450. Between the condenser 430 and the high pressure receiver 440 a first VCS conduit 435 transports high pressure liquid and vapor toward the high pressure receiver 440. Between the high pressure receiver 440 and the expansion valve 450, a second VCS conduit 445 transports high pressure liquid toward the expansion valve 450. Between the expansion valve 450 and the evaporator 410, a third VCS conduit 455 transports low pressure liquid toward the evaporator 410. Between the evaporator 410 and the compressor 420, a fourth VCS conduit 415 transports low pressure vapor toward the compressor 420. Between the compressor 420 and the condenser 430, a fifth VCS conduit 425 transports high pressure vapor toward the condenser 430.

As shown in FIG. 4, a heat exchanger 130 of the ECS 30 is coupled to the evaporator 410. The heat exchanger 130 is between the RAM air inlet 40 and the ECS 30, e.g., along the RAM air conduit 145A. The heat exchanger 130 receives the RAM air flow 145, cools it while transferring heat to the ammonia in coils 410A of the evaporator 410, and cooled RAM air flow 145 is then transported, e.g., via the ECS conduit 30A to the ECS 30.

The embodiments utilize ammonia, which is readily available, as green fuel and as a refrigerant for a vapor cycle.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An aircraft system for pre-heating ammonia that flows toward an ammonia fuel cell, the system comprising:
an ammonia-to-air heat exchanger, having:
a first section through which RAM air flows, a second section through which the ammonia flows and a third section between the first and second sections which includes a solvent, wherein heat energy is transferred from the RAM air to the ammonia via the solvent; and
an ammonia sensor that provides an alert when ammonia is detected in the solvent.

2. The system of claim 1, wherein
the ammonia sensor is in the third section of the heat exchanger.

3. The system of claim 1, wherein
the solvent is sealed in the third section of the heat exchanger.

4. The system of claim 1, wherein
the solvent flows through the third section of the heat exchanger.

5. The system of claim 4, wherein
flow characteristics through the third section of the heat exchanger is adjustable to change a heat transfer rate between the RAM air and the ammonia.

6. The system of claim 4, further including
an environmental control system (ECS) that is fluidly coupled to the third section of the heat exchanger, wherein the ECS receives the solvent from the heat exchanger.

7. The system of claim 6, wherein
an ECS conduit fluidly couples the third section of the heat exchanger and the ECS, and the ammonia sensor is in the ECS conduit.

8. The system of claim 6, including
a secondary aircraft system, fluidly coupled to the ECS, wherein the ECS receives the solvent from the ECS to thereby cool the secondary aircraft system.

9. The system of claim 8, wherein
the secondary aircraft system includes aircraft electronics.

10. The system of claim 1, further including
an ammonia storage system, fluidly coupled to the second section of the heat exchanger, that supplies the ammonia to the heat exchanger.

11. The system of claim 1, further including
an ammonia cracker, fluidly coupled to the second section of the heat exchanger, that receives the ammonia from the heat exchanger.

12. The system of claim 10, further including
an ammonia cracker, fluidly coupled to the second section of the heat exchanger, that receives the ammonia from the heat exchanger.

13. The system of claim 12, further including
a plurality of the heat exchangers including a first heat exchanger in a first conduit that extends between the ammonia storage system and the jet engine and a second heat exchanger between the ammonia storage system and the ammonia cracker.

14. The system of claim 1, further comprising
heat fins within the third section of the heat exchanger.

15. An aircraft system, comprising:
a vapor compression cycle (VCS), that includes ammonia as the working fluid, wherein the VCS includes an evaporator;
a heat exchanger coupled to the evaporator, wherein RAM air flows through the heat exchanger and is cooled by the evaporator.
a secondary system air duct, coupled to the heat exchanger, that receives the RAM air cooled by the evaporator.

16. The system of claim 15, including
an environmental control system (ECS) that is fluidly coupled to the heat exchanger and receives the RAM air that is cooled by the VCS.
